(19) United States
(12) Patent Application Publication
(10) Pub. No.: US 2012/0243878 A1
(43) Pub. Date: Sep. 27, 2012

(54) RADIO FREQUENCY AND DIGITAL SIGNAL DUAL CARRIER MULITPLE MODULATION SYSTEM

(76) Inventors: Timothy Joseph Wurth, Middletown, OH (US); Jeffrey A. Benz, Middletown, OH (US); Jeffrey Scott Wells, Middletown, OH (US)

(21) Appl. No.: 13/071,446

(22) Filed: Mar. 24, 2011

(51) Int. Cl. H04B 10/02; H04L 27/00

(52) U.S. Cl. 398/140

(57) ABSTRACT

The present invention is a radio frequency and digital signal dual carrier multiple modulation system that includes a transmitter system with digital components that include digital inputs, carrier signal sources, a multiplexer and logic controlled radio frequency switches that produces modulated signals and radio frequency components that includes radio frequency signal input and a radio frequency variable gain amplifier. There is also a receiver system with digital components that include a demultiplexer, buffer amplifiers, detectors, comparators and digital signal outputs that receive modulated signals from the transmitter system and radio frequency components with another radio frequency variable gain amplifier that receives the radio frequency output from the transmitter system and produces an amplified radio frequency output.

### TECHNICAL FIELD & BACKGROUND

The present invention generally relates to a radio frequency and digital signal dual carrier multiple modulation (DCMM) system. More specifically, the invention is a radio frequency and digital signal dual carrier multiple modulation system to transfer both digital and radio frequency signals simultaneously across fiber optic cable.

It is an object of the invention to provide a dual carrier multiple modulation system that permits digital signals to be transmitted on one photonic link while radio frequency signals are simultaneously transmitted on a separate photonic link.

It is an object of the invention to provide a DCMM system where a transmitter system and receiver system work together to transfer both digital and radio frequency signals across photonic links in the form of a fiber optic cable.

What is really needed is a radio frequency and digital signal dual carrier multiple modulation system that transfers both digital and radio frequency signals simultaneously across fiber optic cable that permits digital signals to be transmitted on one photonic link while radio frequency signals are simultaneously transmitted on a separate photonic link.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overall system block diagram of a radio frequency and digital dual carrier multiple modulation system, in accordance with one embodiment of the present invention.

FIG. 2 illustrates a flowchart of a transmitter system of a radio frequency and digital dual carrier multiple modulation system, in accordance with one embodiment of the present invention.

FIG. 3 illustrates a flowchart of a receiver system of a radio frequency and digital dual carrier multiple modulation system, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

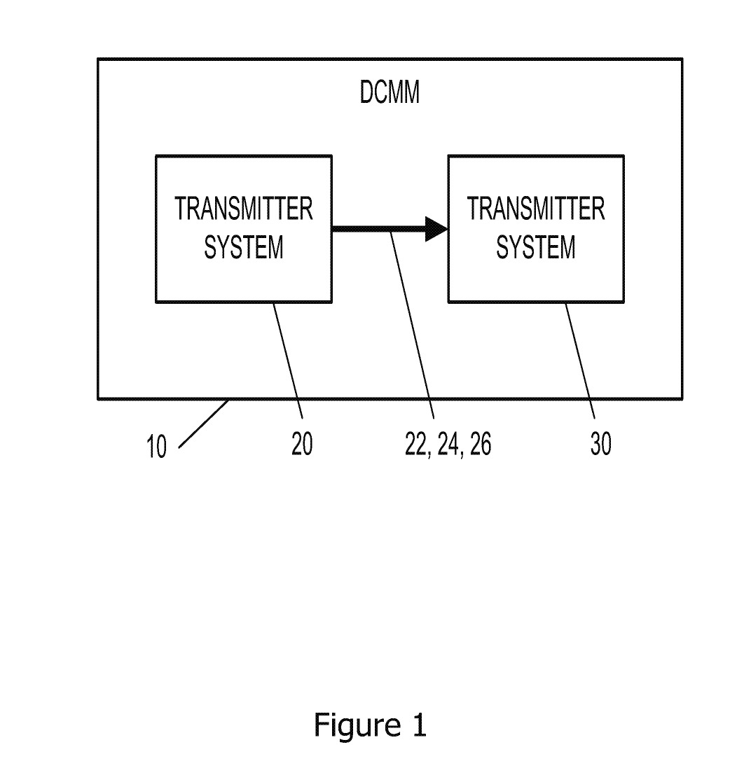

FIG. 1 illustrates an overall system block diagram of a radio frequency and digital dual carrier multiple modulation system 10, in accordance with one embodiment of the present invention. The overall system 10 includes a transmitter system 20 and a receiver system 30 working together to transfer both digital and RF signals across a fiber optic cable 22. The frequency content and bandwidth of the digital signals and RF signals are independent and their isolation is inherent in the design resulting in very low cross-coupling between the RF and digital transferred signals. The dual carrier multi-modulation system 10 utilizes a dual carrier multi-modulation technique which permits digital signals to be transmitted on one photonic link 24 of the fiber optic cable 22 while RF signals are simultaneously transmitted on another photonic link 26 of the fiber optic cable 22.

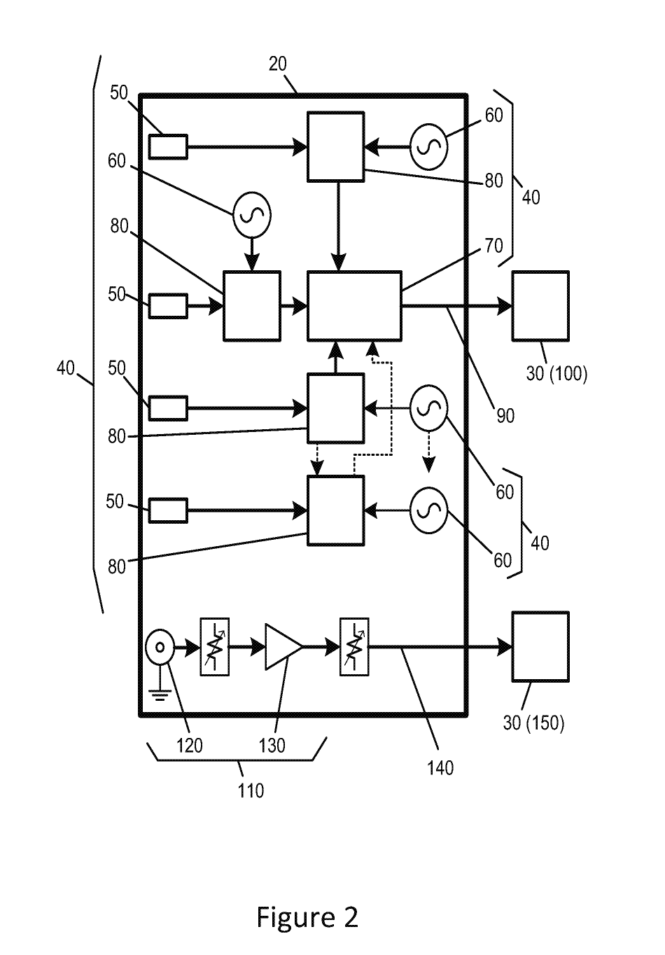

FIG. 2 illustrates a flowchart of a transmitter system 20 of a radio frequency and digital dual carrier multiple modulation system 10, in accordance with one embodiment of the present invention. The transmitter system 20 includes a first plurality of digital components 40 that include a plurality of digital inputs 50, a plurality of carrier signal sources 60, a multiplexer 70 and a plurality of logic controlled radio frequency switches 80 that produces a plurality of modulated signals 90 to the receiver system 30 or a first optical output device 100. There is also a first plurality of radio frequency components 110 that includes a received radio frequency signal input 120 and a first radio frequency variable gain amplifier 130 that produces an amplified first radio frequency signal output 140 to the receiver system 30 or second optical device 150. The digital inputs 50 can be of any logic level that is a digital signal where the switches 80 are turned on and off at a rate that the digital signals 60 are applied to the digital inputs 50. The signal sources 60 are also at different frequencies where the signal sources 60 have limited cross-modulation. The multiplexer 70 combines the modulated carrier sources into a single input to the first optical output device 100 so that the combining causes minimal mixing of the signal carriers 60. In each switch 80 there is a signal source 60 which is AM modulated by the digital input 50. By using a modulated carrier signal 90, digital control signals such as latches and enables can be effectively converted to an optical signal, transmitted and converted back to the original signal.

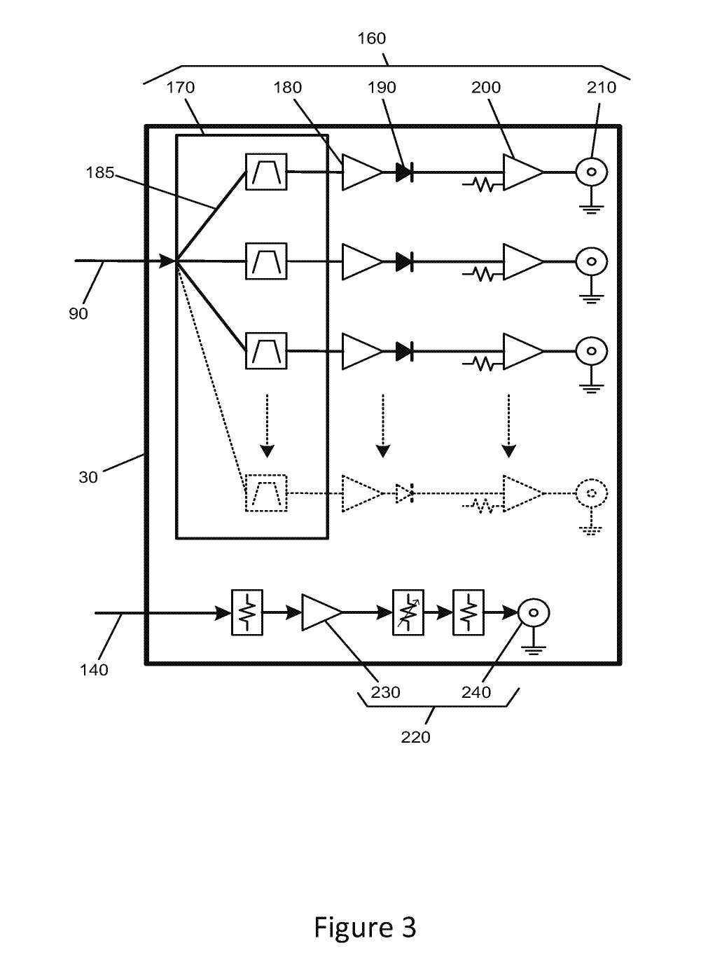

FIG. 3 illustrates a flowchart of a receiver system 30 of a radio frequency and digital dual carrier multiple modulation system 10, in accordance with one embodiment of the present invention. The receiver system 30 includes a second plurality of digital components 160 that include a demultiplexer 170, a plurality of buffer amplifiers 180, a plurality of detectors 190, a plurality of comparators 200 and a plurality of digital signal outputs 210 that receive the modulated signals 90 from the transmitter system 20 and a second plurality of radio frequency components 220 with a second radio frequency variable gain amplifier 230 that receives the first radio frequency output 140 and produces a second amplified radio frequency output 240. The received modulated signals 90 are applied to the demultiplexer 170 and separated and applied to the buffer amplifiers 180. The buffer amplifiers 180 then amplify and condition the separated modulated carriers 185. The detectors 190 then remove the modulated carriers 185 from the modulated signals 90 and apply detected digital data (not shown) and the control signals 90 to the comparators 200. The comparators 200 then detect the digital data and the control signals 90 to desired logic levels and apply the signal output 210. The digital signal outputs 210 are ancillary digital circuitry (not shown) but are not limited to just ancillary digital circuitry and can be any digital output well known in the art. The amplified first RF signal output 140 from the transmitter system 20 is received by the receiver system 30. The amplified first RF signal 140 is applied to a variable gain amplifier 220 where it is further amplified. This further amplified signal is sent from the receiver system 30 as second amplified radio frequency output 240.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A radio frequency and digital signal dual carrier multiple modulation system, comprising:
a transmitter system with a first plurality of digital components that include a plurality of digital inputs, a plurality of carrier signal sources, a multiplexer and a plurality of logic controlled radio frequency switches that produces a plurality of modulated signals to a first optical output device and a first plurality of radio frequency components that includes a received radio frequency signal input and a first radio frequency variable gain amplifier that produces an amplified first radio frequency signal output to a second optical device; and
a receiver system with a second plurality of digital components that include a demultiplexer, a plurality of buffer amplifiers, a plurality of detectors, a plurality of comparators and a plurality of digital signal outputs that receive said modulated signals from said transmitter system and a second plurality of radio frequency components with a second radio frequency variable gain amplifier that receives said first radio frequency output and produces a second amplified radio frequency output.

2. The system according to claim 1, wherein said digital inputs can be of any logic level that constitute a digital signal.

3. The system according to claim 1, wherein said switches are turned on and off at a rate that said digital signals are applied to said digital inputs.

4. The system according to claim 1, wherein said signal sources are at different frequencies.

5. The system according to claim 4, wherein said signal sources have limited cross-modulation.

6. The system according to claim 1, wherein said multiplexer combines said modulated carrier sources into a single input to transmit to said first optical output device.

7. The system according to claim 1, wherein said combining causes minimal mixing of said signal carriers and cross-modulation.

8. The system according to claim 1, wherein said first optical device is said receiver system.

9. The system according to claim 1, wherein said second optical device is said receiver system.

10. The system according to claim 1, wherein said buffer amplifiers amplify and condition said separated modulated carriers.

11. The system according to claim 1, wherein said detectors remove said signal carriers from said modulated signals and apply detected digital data and said control signals to said comparators.

12. The system according to claim 11, wherein said comparators detect said digital data and said control signals to desired logic levels and apply said signal output.

13. The system according to claim 1, wherein said digital signal outputs are ancillary digital circuitry.
